(19) United States
(12) Patent Application Publication
(10) Pub. No.: US 2005/0005114 A1
(43) Pub. Date: Jan. 6, 2005

(54) Ticket-based secure time delivery in digital networks

(75) Inventor: Alexander Medvinsky, San Diego, CA (US)

Correspondence Address: CARPENTER & KULAS, LLP, 1900 EMBARCADERO ROAD, SUITE 109, PALO ALTO, CA, 94303, US

(73) Assignee: General Instrument Corporation, Horsham, PA (US)

(21) Appl. No.: 10/613,911

(22) Filed: Jul. 5, 2003

(51) Int. Cl. H04L 9/00

(52) U.S. Cl. 713/168

(57) ABSTRACT

A ticket-based secure time protocol is used to provide client devices, or users, with secure time signals. In a preferred embodiment, the secure time signals are provided by a secure time server so that multiple clients can be time-synchronized. Ticket-based authentication uses digital certificates and public key cryptography, such as Elliptic Curve Cryptography (ECC) to reduce key administration overhead and decryption processing. Standard authentication architectures and approaches, such as Kerberos, can be used for some aspects of the invention. A preferred embodiment uses Request and Reply messages that provide added security and functionality, such as authentication, sequence-checking and verification of target destination.

### CROSS-REFERENCES TO RELATED APPLICATIONS

This application is related to the following co-pending U.S. patent applications which are hereby incorporated by reference as if set forth in full in this specification:
Ser. No. 10/334,606, filed on Dec. 30, 2002, entitled “SYSTEM FOR DIGITAL RIGHTS MANAGEMENT USING DISTRIBUTED PROVISIONING AND AUTHENTICATION;” (docket 018926-009900US, D2990); and
Ser. No. ______ [TBD], filed on ______ [TBD], entitled “ENFORCEMENT OF PLAYBACK COUNT IN SECURE HARDWARE FOR PRESENTATION OF DIGITAL PRODUCTIONS” (docket 018926-010500US, D3041).

### BACKGROUND OF THE INVENTION

1. Field of the Invention

1021 This invention relates in general to transfer of information over digital networks and more specifically to ticket-based secure time delivery in a digital rights management (DRM) system.

2. Description of the Background Art

Today's digital systems deal with many types of information, or content, used in commerce, education, entertainment, banking, government, etc. Often, such information is transferred over a digital network such as the Internet, local-area network (LAN), campus or home network, or other communication link or scheme. Data security is a major issue for networks. Because proprietary data may be transferred to devices and communication links that are not under the complete control of owners of data, such data is prone to unauthorized access or use by “attackers,” or “hackers.”

For example, owners of digital content, such as a movie or song, may wish to restrict a user from playing back the audio or video content if the user has not properly paid for, or subscribed to, such use. Such restrictions on content are often time-based because access to content can be regulated according to a time interval such as a month, day, hours, etc. Besides licenses to use data, other information, such as data that changes or is superceded, etc., can also be time-sensitive and may need to expire after a time interval. Many other types of restrictions, permissions, or controls may require a time-based approach.

Time-based controls of digital information require a reliable and secure time source. For example, a time server can be used to provide user devices (e.g., digital content playback devices such as a set-top box) with a secure time reference. In such an approach, public key encryption is used to set up a client session in which secure time updates are provided. The secure time updates can be achieved with symmetrical keys to reduce computation overhead. However, periodic public key (i.e., asymmetric key) operations are still required and can require prohibitively complex, resource consuming operations—especially when many clients are using the same time server.

Another problem with traditional secure time servers is that fail-over and load balancing operations are costly and may be difficult, or prohibitive, to execute. Both fail-over and load balancing require users to be redirected to another time server. If the new time server can not be set up quickly with the transferred users, then unwanted delays and possible suspension, or complete loss, of operation may result.

### SUMMARY OF EMBODIMENTS OF THE INVENTION

The invention uses a secure time protocol to provide client devices, or users, with secure time signals. In a preferred embodiment, the secure time signals are provided by a secure time server so that multiple clients can be time-synchronized, if desired. Ticket-based authentication uses symmetric key cryptography such as AES or 3-DES to reduce encryption, decryption and digital signature processing. At the same time, the preferred solution uses digital certificates and public key cryptography, such as Elliptic Curve Cryptography (ECC) during a client registration phase with the Key Distribution Center (KDC) in order to reduce key administration overhead.

Standard authentication architectures and approaches, such as Kerberos, can be used for some aspects of the invention. However, the preferred embodiment uses enhancements to optimize response times and reduce resource needs, and to provide added functionality.

These provisions together with the various ancillary provisions and features which will become apparent to those artisans possessing skill in the art as the following description proceeds are attained by devices, assemblies, systems and methods of embodiments of the present invention, various embodiments thereof being shown with reference to the accompanying drawings, by way of example only, wherein:

In one embodiment the invention provides a method for providing a secure time signal from a time source to a time requester over a digital network, the method comprising using a ticket to request the secure time signal.

### BRIEF DESCRIPTION OF THE DRAWINGS

FIG. 1A shows components in an Internet Protocol Rights Management (IPRM) system suitable for use with the present invention;

FIG. 1B shows additional components relating to home domain access of information provided by a digital rights management (DRM) system such as the IPRM system of FIG. 1A; and

FIG. 2 shows a ticket-based secure time server system according to a preferred embodiment of the invention.

### DETAILED DESCRIPTION OF EMBODIMENTS OF THE INVENTION

A preferred embodiment of the invention is used with a specific digital rights management (DRM) architecture that is discussed in the related patents, cited above. This architecture is referred to as an Internet Protocol Rights Management (IPRM) system. It should be apparent that different embodiments can use different DRM architectures and features than those discussed herein and in the related related patent applications. Different logical and/or physical components than those discussed for the IPRM can be used. Not all components need to be used in any given DRM architecture, and additional components, interconnections, functions and working relationships can be employed. The invention can also be used, in general, for providing secure time to an arbitrary network, or computing system.

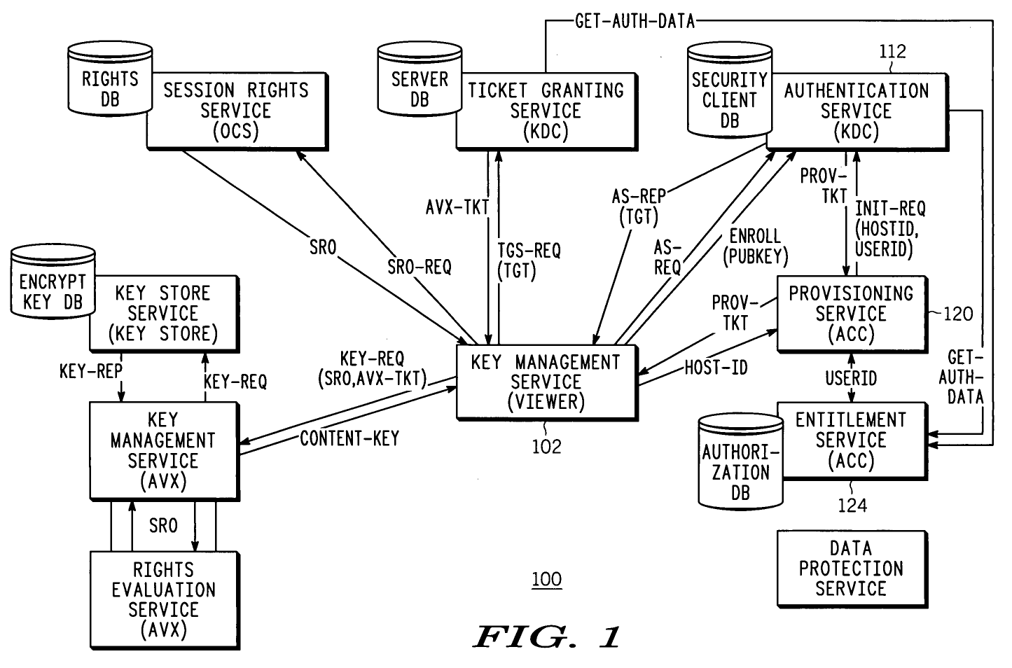

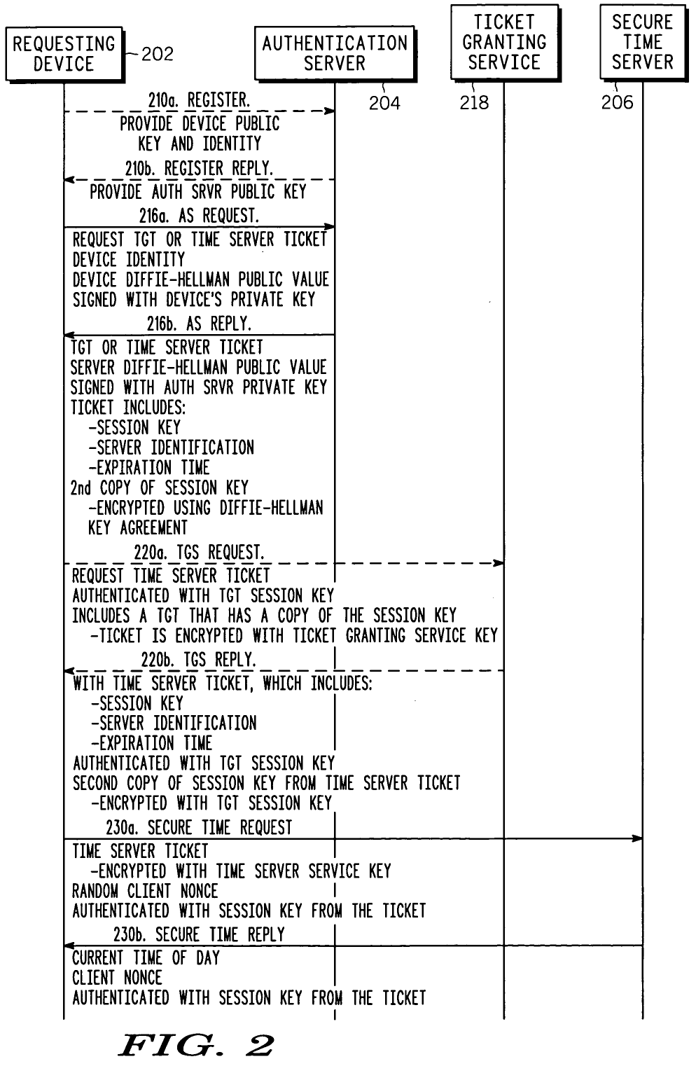

FIG. 1A shows components in an Internet Protocol Rights Management (IPRM) system suitable for use with the present invention.

In FIG. 1A, logical components are shown in boxes with an indication of the physical component that is, preferably, used to perform the functionality of the logical component in parenthesis. Note that FIG. 1A is merely a broad, general diagram of a one content distribution system. The functionality represented by logical components can vary from that shown in FIG. 1A and still remain within the scope of the invention. Logical components can be added, modified or removed from those shown in FIG. 1A. The physical components are examples of where logical components described in the diagram could be deployed. In general, aspects of the present invention can be used with any number and type of devices interconnected by a digital network.

FIG. 1A shows interfaces in the IPRM designed for secure content distribution and for the enforcement of rights of content and service providers. Such a system is used, for example, with satellite and cable television distribution channels where standard television content, along with digital information such as files, web pages, streaming media, etc., can be provided to an end user at home via a set-top box. IPRM system 100 is illustrated using a few exemplary logical components. In an actual system, there will be many more instances of specific logical components. For example, key management service 102 is intended to execute at a user, or viewer location. Naturally, there will be millions of viewers in a typical cable television network.

The general purpose and operation of various of the entities of FIG. 1A, such as provisioning service (PS) 120, authentication service (AS) 112, entitlement service 124, client processors and other servers and devices are well-known in the art. A system such as that shown in FIG. 1A is discussed in more detail in co-pending patent application SYSTEM FOR DIGITAL RIGHTS MANAGEMENT USING DISTRIBUTED PROVISIONING AND AUHENTICATION, referenced above. The device security ratings system of the present invention can be used among any of the components and physical and logical devices shown in FIG. 1A so that a decision can be made whether to transfer content, or other information, from an inquiring device to a target device.

FIG. 1B shows additional components relating to home domain access of information provided by a DRM system such as the IPRM system of FIG. 1A. The system of FIG. 1B can be considered as a subsystem, additional system, or overlay to that of FIG. 1A. Although FIG. 1B shows hardware devices, such devices (e.g., viewer 158) can perform portions or combinations of the functions or services described in FIG. 1A.

In FIG. 1B, viewer 158 can be a display device, audio playback device, or other media presentation device, such as a television or computer. Viewer 158 is associated with local playback devices for playback of content, such as uncompressed digital media player 152, compressed digital media player 154 and analog media player 162. Such local devices are part of an “authorized domain” of equipment that is easily accessed by a user, or consumer, as illustrated by devices at 180. Note that the authorized domain can include additional networks, such as Ethernet, wireless, home phone network adapter (PNA), etc. and any number and types of devices for accessing, transferring, playing, creating, and managing content.

The authorized domain presents a special problem to security since it typically places content directly at the control of a user. As indicated in FIG. 1B, various devices may provide a user with content in various formats such as uncompressed, compressed, analog, stored, encrypted, etc. Other ways to provide content to the viewer are from remote devices such as conditional access center 150 using multicast streaming server 156 or unicast streaming server 160. Origin server 164 represents other content sources such as, e.g., a third party web site.

Information can be stored locally or remotely from the authorized domain. Sensitive information such as content decryption keys 170, encrypted content 172 and rules and metadata 174 might commonly be stored in devices that are accessible by the user. The system of the present invention can be used to improve security and rights enforcement in components and devices such as those shown in FIG. 1B by providing delivery of secure time signals to one or more of the components and devices. For example, a secure time service according to the present invention can be used to restrict playback of digital video as described in co-pending patent application entitled “ENFORCEMENT OF PLAYBACK COUNT IN SECURE HARDWARE FOR PRESENTATION OF DIGITAL PRODUCTIONS,” referenced above.

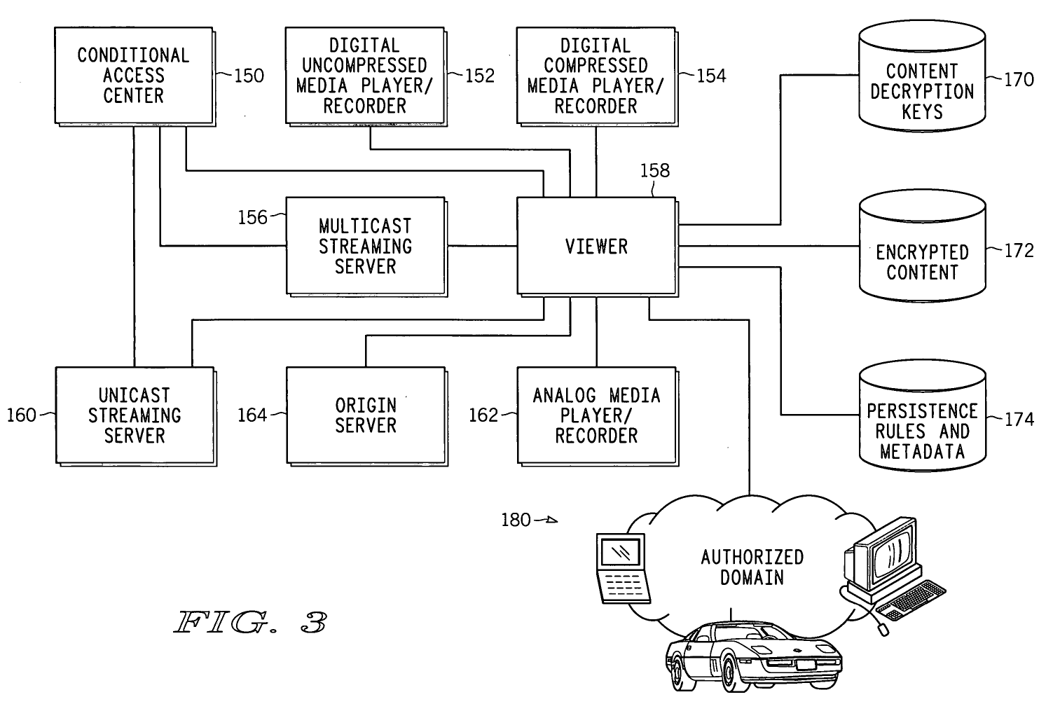

FIG. 2 shows a ticket-based secure time server system according to a preferred embodiment of the invention.

In FIG. 2, requesting device 202 (or “client”) desires to obtain a secure time signal from secure time server 206 by using a ticket obtained from the Authentication Server 204 or from the Ticket Granting Service 218. The functionality in each of these components 202, 204, 206 and 218 can be implemented by any of the components and devices of FIGS. 1A and 1B, or in any other suitable devices or components. Typically, Authentication Server 204 and Ticket Granting Service 218 are combined into a single server called KDC (Key Distribution Center).

Requesting device 202 may optionally first register with the Authentication Server 204 at some time prior to a request for a secure time signal. Such registration is shown in FIG. 2 at 210a and 210b. At a minimum, registration includes storing a record of a public key corresponding to each device, and an identification of the device. In other words, requesting device 202 provides its public key and identification information to Authentication Server 204. A common and secure way for a device to provide this information is by sending its digital certificate. In a registration reply 210b the Authentication Server may also return its public key, typically inside a digital certificate. Device registration performed during steps 210a and 210b may be skipped if the subsequent AS Request 216a and AS Reply 216b messages include digital certificates that identify the device and Authentication Server respectively.

A requesting device can be a media playback device, such as a set top box, or another device or component, such as a server, processor, storage, transfer or other device that may desire a secure time signal. The secure time server is typically a device, or process executing on a device, that is under the control of an administrator or security management entity for a portion of a network. The requesting device, key distribution center and secure time server are typically located in different places and are connected by the Internet and/or other suitable network or communication links. Other embodiments can include additional, or fewer, features and processes than those presented herein. More than one key distribution center can be used, as where a multi-realm approach is implemented for a large network.

KDC 106 is a trusted authority for authenticating clients, and for distributing session keys between a client and an application server, such as a secure time server. These session keys establish secure sessions between the client and the application server. A KDC may be based on the Kerberos protocol which is based on an IETF (Internet Engineering Task Force) standard. Or, it may be based on some other, proprietary protocol such as ESBroker, implemented by Motorola, Inc., of San Diego, Calif.

The Kerberos protocol provides key management and authentication functionalities related to the client's ability to access content. The Kerberos protocol is well known in the art for providing client/server authentication and is used in a preferred embodiment. For example, a public key-based digital signature can be used in order to authenticate a client that is requesting a ticket from the KDC. An optional certificate can also be included in a ticket request or provided to the KDC before the ticket request is sent. KDC client authentication can also use a symmetric, password-derived key. In general, any suitable authentication approach can be employed. By using Kerberos, a KDC may provide a single user with access to multiple computing systems on the network. This is done by issuing multiple tickets to the user.

A ticket is typically an authentication token, or other information object, provided to a client by the KDC. Among other information, a ticket can contain the name of the client, name of a specific server and a session key (a symmetric encryption key). Other embodiments may have tickets with more or less information. The client name and session key are kept secret and are encrypted with another key, called a service key. The service key is a secret key that is known only to the KDC and the server named in the ticket. Because the client does not also possess this service key, it does not have the ability to decrypt the ticket and change its contents. Normally, the client also needs to know the session key and since it cannot get it out of the ticket, the KDC sends to this client a separate copy of the same session key.

When a client, such as requesting device 202, wishes to access secure time server 206 it contacts Authentication Server 204 (typically part of the KDC). Authentication Server 204 then verifies whether the client is authorized to access the secure time server. This verification is done by performing an authentication service Request/Reply message exchange (216a and 216b), where both messages are authenticated using a digital signature and include the identities of the client device and the Authentication Server.

After the AS Request 216a is received by the Authentication Server 204 and the client is authenticated, the Authentication Server issues a ticket containing a session key and returns it in the AS Reply 216b. AS Request/Reply exchange also utilizes a Diffie-Hellman key agreement algorithm allowing each party on each end to generate the same symmetric key for encrypting/decrypting private information in the AS Reply (which includes a second copy of the session key). In one approach, this ticket is valid for a designated duration. In another approach, the KDC simply records when the ticket was issued. Other approaches are possible. After the ticket is issued, the session key is used by the client for authenticating its secure time request for the secure time server 206.

The ticket issued by the KDC and returned in 216b can be a ticket to directly request a server's service, or it can be a ticket-granting-ticket (TGT) as shown at 216b of FIG. 2. The TGT allows subsequent requests of a service to be more efficient by allowing the client to obtain server tickets from ticket granting service (TGS) 218 using symmetric key authentication which is faster than public key authentication using digital signatures. The TGT is used to authenticate a TGS Request/Reply exchange. The TGS Request 220a includes a TGT and is authenticated using the TGT session key. The TGS Reply 220b contains a newly issued Secure Time Server (STS) ticket and a second copy of the STS session key that is encrypted with the TGT session key. Note that, in the case where a TGT is not used, the client makes an AS Request 216b that asks directly for a STS ticket from the Authentication Server and the STS ticket is returned in the AS Reply 216b.

The requesting device can send the ticket, along with any other information if desired, at, or before, a time when the device desires to receive secure time information. In FIG. 2, the requesting device sends a ticket and authenticator in a message called TIME_REQ to the secure time server at 230a. The private part of the ticket (which includes the session key) remains encrypted with the secure time server's symmetric service key. The authenticator includes a symmetric key signature, commonly known as a Message Authentication Code (MAC) or a keyed checksum, where the MAC can only be computed or validated with the session key.

The secure time server is thus able to decrypt the private part of the ticket with its service key, then extract the session key and use it to authenticate the requesting device. Note that other embodiments need not use this approach to authentication. For example, the requesting device authentication may not be necessary (the primary security concern is that the reply from the time server is authenticated, to make sure that the time reading is valid).

The secure time server replies to the request for secure time information by sending a secure time message, called TIME_REP, at 240 authenticated with the session key, e.g., using a MAC that is keyed with the session key extracted from the ticket. The use of a session key obtained from the ticket allows faster processing of secure time messages since the session key is a symmetric key that provides efficiencies over more complex approaches such as a public key approach.

Note that many refinements to this approach are possible. For example, a ticket-granting server can be used so that the initial ticket received from the authentication server can be a ticket-granting-ticket, as is known in the art. Depending on the application, network, user base, etc., a requirement for greater, or less, security can dictate the extent to which precautions, checks, key length and complexity, timeouts, etc., are used.

Next, specific formats for time request, and time reply, messages are presented. Note that, in general, any suitable format can be used to convey the desired request and reply. For example, messages, data, signals or other information exchange can be employed.

Message TIME_REO

The message TIME_REQ is sent to a secure time server when a requesting device, or client, wants a secure update to its current time. For example, clients that implement Digital Rights Management may need the ability to expire content licenses. Expiration can be based on time signals from a secure time server.

This message is sent to a secure time server that shares a symmetric service key with the KDC. The client is required to first obtain a ticket for this time server from the KDC. If performance allows for it, it is possible to co-host the KDC and a secure time server on the same host—but in either case, the client is still required to first obtain a ticket for this secure time server.

The format of a TIME_REQ message is shown in Table I, below.

TABLE I

| Attributes | Description |
|---|---|
| Client Nonce | A pseudo-random integer value generated by the client. |
| ServiceTicket | A ticket for a Time Server. It identifies the client and |
| | provides a session key for computing the keyed |
| | checksum in the Signature attribute. |
| MAC | Keyed checksum over this message. |

In Table I, TIME_REQ includes a service ticket obtained from an authentication server, key distribution center, or similar source in a manner as discussed, above. A symmetric key-based signature (e.g., a MAC) is also provided to allow the secure time server to authenticate the client. Any type of a symmetric key-based signature can be generated by any means as is known in the art. Other authentication approaches can be used and in some cases authentication of the request may not even be necessary. Table I also shows that TIME_REQ includes a pseudo-random client nonce value. A nonce can be an integer value with a very low probability of recurrence, generated by the client. Typically, this value will be generated as a pseudo-random number. In a preferred embodiment, this client nonce is used later by the client to validate the TIME_REP message—to make sure that it is a real reply from the time server and not a reply that was recorded earlier and then resent by an attacker.

After the client sends out the TIME_REQ it saves the client nonce value in order to later validate the matching TIME_REP message from the KDC. The client keeps the client nonce until a configurable time out value. After the time out, the client will no longer be able to process the corresponding TIME_REP and must retry.

Since the TIME_REQ message does not create any state within a secure time server and since returning an authenticated error message may require as much resources as returning current time, the secure time server in the preferred embodiment does not check for replays (a form of attack) of TIME_REQ messages.

After receiving the TIME_REQ, the time server verifies that both the ticket and the MAC over the message are both valid If no errors are generated during the processing of the TIME_REQ message, the Time Sever replies with the TIME_REP message.

Message TIME_REP

This message is a reply from the time server to a TIME_REQ message and it provides a current time reading to the client.

This message is authenticated with a keyed checksum, using the same session key that was used to authenticate the request. The format for the TIME_REP message is shown in Table IV, below.

TABLE IV

| Attributes | Description |
|---|---|
| Client Nonce | Copied from TIME_REQ |
| CurrentTime | Current time. |
| MAC | Keyed checksum over this message. It is |
| | keyed with the session key from the service |
| | ticket in the TIME_REQ. |

The client verifies the MAC and the client nonce field and if validation succeeds, then accepts the received time reading.

Although the invention has been discussed with respect to specific embodiments thereof, these embodiments are merely illustrative, and not restrictive, of the invention.

A ticket can vary in the amount and type of information it includes. Although a ticket in a preferred embodiment includes an identification of the requesting device and a session key, additional information, such as a timestamp, user identification, content license rights, etc., can be included in the ticket.

Different security approaches can be used. For example, different methods of encryption can be used. The selection of which information to encrypt or encode and the authentication and authorization methods of the present invention can be varied and still be within the scope of the invention. Other aspects of the specific embodiments presented herein can be modified.

Although the invention proposes specific types of messages such as TIME_REQ and TIME_REP, and specific formats for these messages, any suitable type and number of messages and message formats can be used. For example, the TIME_REP message may include additional information such as client name and realm corresponding to the requestor.

Any suitable programming language can be used to implement the routines of the present invention including C, C++, Java, assembly language, etc. Different programming techniques can be employed such as procedural or object oriented. The routines can execute on a single processing device or multiple processors. The functions of the invention can be implemented in routines that operate in any operating system environment, as standalone processes, in firmware, dedicated circuitry or as a combination of these or any other types of processing.

Steps can be performed in hardware or software, as desired. Note that steps can be added to, taken from or modified from the steps in the flowcharts presented in this specification without deviating from the scope of the invention. In general, descriptions of functional steps, such as in tables or flowcharts, are only used to indicate one possible sequence of basic operations to achieve a functional aspect of the present invention.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer” for purposes of embodiments of the present invention may be any processor-containing device, such as a mainframe computer, a personal computer, a laptop, a notebook, a microcomputer, a server, or any of the like. A “computer program” may be any suitable program or sequence of coded instructions that are to be inserted into a computer, well known to those skilled in the art. Stated more specifically, a computer program is an organized list of instructions that, when executed, causes the computer to behave in a predetermined manner. A computer program contains a list of ingredients (called variables) and a list of directions (called statements) that tell the computer what to do with the variables. The variables may represent numeric data, text, or graphical images.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” includes a system or mechanism that interprets and executes instructions (e.g., operating system code) and manages system resources. More particularly, a “processor” may accept a program as input, prepares it for execution, and executes the process so defined with data to produce results. A processor may include an interpreter, a compiler and run-time system, or other mechanism, together with an associated host computing machine and operating system, or other mechanism for achieving the same effect. A “processor” may also include a central processing unit (CPU) which is a unit of a computing system which fetches, decodes and executes programmed instruction and maintains the status of results as the program is executed. A CPU is the unit of a computing system that includes the circuits controlling the interpretation of instruction and their execution.

A “server” may be any suitable server (e.g., database server, disk server, file server, network server, terminal server, etc.), including a device or computer system that is dedicated to providing specific facilities to other devices attached to a network. A “server” may also be any processor-containing device or apparatus, such as a device or apparatus containing CPUs. Although the invention is described with respect to a client-server network organization, any network topology or interconnection scheme can be used. For example, peer-to-peer communications can be used.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Further, at least some of the components of an embodiment of the invention may be implemented by using a programmed general purpose digital computer, by using application specific integrated circuits, programmable logic devices, or field programmable gate arrays, or by using a network of interconnected components and circuits. Any communication channel or connection can be used such as wired, wireless, optical, etc.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

1. A method for providing a secure time signal from a time source to a time requestor over a digital network, the method comprising
using an information object to request the secure time signal wherein the information object includes an identification of the requestor and a session key for transferring the secure time signal.

2. The method of claim 2, wherein the information object includes a ticket.

3. The method of claim 2, wherein the ticket is obtained from a key distribution center.

4. The method of claim 2, wherein the ticket is obtained from an authentication server.

5. The method of claim 2, wherein the ticket is obtained from a ticket-granting-server.

6. The method of claim 2, further comprising
associating a request for a secure time signal with the ticket;
transferring the ticket with the request to a secure time server; and
receiving a secure time signal from the secure time server.

7. The method of claim 6, wherein the request includes a request message, the method further comprising
generating a nonce to be included in the request message;
including a service ticket for the secure time server in the request message; and
including a keyed checksum over the request message

8. The method of claim 6, wherein the secure time signal includes a reply message, the method further comprising
including a secure time signal;
including a nonce copied from the client request;
including a keyed checksum over the reply message

9. The method of claim 6, wherein the step of receiving a secure time signal includes the following substeps:
matching a nonce in the received message with the corresponding nonce in the sent message; and
confirming a keyed checksum.

10. The method of claim 6, further comprising
using the secure time signal to update a clock value.

11. An apparatus for providing a secure time signal to a time requestor over a digital network, the apparatus comprising
a process for accepting a ticket from the time requestor to request a secure time signal; and
a process for providing a secure time signal to the time requestor.

12. An apparatus for providing a secure time signal to a time requestor over a digital network, the apparatus comprising
means for accepting a ticket from the time requestor to request a secure time signal; and
means for providing a secure time signal to the time requestor.

13. A computer-readable medium including instructions for providing a secure time signal to a time requestor over a digital network, the computer-readable medium comprising
one or more instructions for accepting a ticket from the time requestor to request a secure time signal; and
one or more instructions for providing a secure time signal to the time requester.
